(19) United States
(12) Patent Application Publication
(10) Pub. No.: US 2026/0003171 A1
(43) Pub. Date: Jan. 1, 2026

(54) OPTICAL DELAY GENERATOR AND SPECTROSCOPIC APPARATUS INCLUDING SAME

(71) Applicant: Samsung Electronics Co., Ltd., Suwon-si (KR)

(72) Inventors: Sunhong Jun, Suwon-si (KR); Inkeun Baek, Suwon-si (KR); Wontae Kim, Suwon-si (KR); Taejoong Kim, Suwon-si (KR); Eunhyuk Choi, Suwon-si (KR)

(21) Appl. No.: 19/029,126

(22) Filed: Jan. 17, 2025

(30) Foreign Application Priority Data
Jun. 27, 2024 (KR) 10-2024-0084635

(51) Int. Cl. G02B 17/02; G01N 21/25; G02B 26/08; G02B 26/12; G02B 27/28

(52) U.S. Cl. CPC G02B 17/023; G01N 21/255; G02B 26/0833; G02B 26/129; G02B 27/283

(57) ABSTRACT

An optical delay generator includes a polarizing beam splitter configured to split an incident beam by reflecting or transmitting the incident beam depending on the polarization state, a rotating polygonal mirror configured to reflect the incident beam reflected from the polarizing beam splitter to provide a first reflected beam, a micromirror array configured to reflect the first reflected beam and configured to provide a second reflected beam back to the rotating polygonal mirror, and a phase delay member between the polarizing beam splitter and the rotating polygonal mirror, wherein the polarizing beam splitter is configured to provide an output beam by transmitting a third reflected beam provided by reflecting the second reflected beam from the rotating polygonal mirror, and the output beam has an optical delay difference with respect to the incident beam.

### CROSS-REFERENCE TO RELATED APPLICATION

This application claims priority to and the benefit of Korean Patent Application No. 10-2024-0084635 filed at the Korean Intellectual Property Office on Jun. 27, 2024, the entire contents of which are incorporated herein by reference.

### FIELD

The present disclosure relates to an optical delay generator and a spectroscopic apparatus including the same.

### BACKGROUND

In general, an optical delay generator includes of a combination of a linear moving mirror or a prism. Light incident on and reflected by the linear moving mirror proceeds in the original direction, thereby generating optical delay. This optical delay generator has a relatively simple structure and large optical delay range, but the driving speed may be relatively slow due to difficulty of changing the optical delay difference at a high and constant speed.

### SUMMARY

Embodiments provide an optical delay generator and a spectroscopic apparatus that can improve driving speed by changing the optical delay difference at a high and substantially constant speed.

An optical delay generator according to an embodiment comprises a polarizing beam splitter configured to split an incident beam by reflecting or transmitting the incident beam depending on the polarization state, a rotating polygonal mirror configured to reflect the incident beam reflected from the polarizing beam splitter to provide a first reflected beam, a micromirror array configured to reflect the first reflected beam and configured to provide a second reflected beam back to the rotating polygonal mirror, and a phase delay member between the polarizing beam splitter and the rotating polygonal mirror, wherein the polarizing beam splitter is configured to provide an output beam by transmitting a third reflected beam provided by reflecting the second reflected beam from the rotating polygonal mirror, and the output beam has an optical delay difference with respect to the incident beam.

A spectroscopic apparatus according to an embodiment comprises a beam generator that configured to generate a pulse beam, a beam splitter configured to separate the pulse beam generated by the beam generator into a first pulse beam and a second pulse beam, an optical delay generator configured to provide an optical delay beam by optically delaying the first pulse beam, an irradiator configured to irradiate the optical delay beam and the second pulse beam to a sample, and a detector configured to detect a response of the sample to the optical delay beam and the second pulse beam, wherein the optical delay generator comprises a polarizing beam splitter configured to split the first pulse beam by reflecting or transmitting the first pulse beam depending on the polarization state, a rotating polygonal mirror configured to reflect the first pulse beam reflected from the polarizing beam splitter to provide a first reflected beam, a micromirror array configured to reflect the first reflected beam and configured to provide a second reflected beam back to the rotating polygonal mirror, and a phase delay member between the polarizing beam splitter and the rotating polygonal mirror, wherein the polarizing beam splitter is configured to provide an output beam by transmitting a third reflected beam provided by reflecting the second reflected beam from the rotating polygonal mirror, wherein the output beam has an optical delay difference with respect to the first pulse beam.

According to the embodiments, by generating an optical delay difference between an incident beam and an output beam using a rotating polygonal mirror and a micromirror array, the optical delay difference may be varied at high speed.

Additionally, by rotating the rotating polygonal mirror at a substantially constant speed, the optical delay difference may be varied at a substantially constant speed, and thus the optical delay difference may be changed linearly.

Further, by changing the optical delay difference at a high and constant speed, the driving speed and signal-to-noise ratio of the spectroscopic apparatus may be improved.

### BRIEF DESCRIPTION OF THE DRAWINGS

FIG. 1 is a schematic diagram of an optical delay generator according to an embodiment.

FIGS. 2, 3, and 4 are diagrams illustrating a method of generating optical delay while rotating the rotating polygonal mirror of FIG. 1.

FIG. 5 is a graph showing the optical delay difference according to the rotation angle of the rotating polygonal mirror of FIG. 1.

FIG. 6 is a graph showing the optical delay difference over time in the optical delay generator of FIG. 1.

FIG. 7 is a schematic diagram of a spectroscopic apparatus including an optical delay generator according to an embodiment.

### DETAILED DESCRIPTION OF EMBODIMENTS

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive. Like reference numerals designate like elements throughout the specification.

Size and thickness of each constituent element in the drawings are arbitrarily illustrated for better understanding and ease of description, but the following embodiments are not limited thereto. In the drawings, the thickness of layers, films, panels, regions, etc., are exaggerated for clarity. In the drawings, the thickness of some layers and regions may be exaggerated for case of description.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

In addition, unless explicitly described to the contrary, the word “comprise,” and variations such as “comprises” or “comprising,” will be understood to imply the inclusion of stated elements but not the exclusion of any other elements.

The terms “first,” “second,” etc., may be used herein merely to distinguish one component, layer, direction, etc. from another. The term “and/or” includes any and all combinations of one or more of the associated listed items.

In addition, the phrase “on a plane” means a view from a position above the object (e.g., from the top) or in plan view, and the phrase “on a cross-section” means a view of a cross-section of the object which is vertically cut from the side.

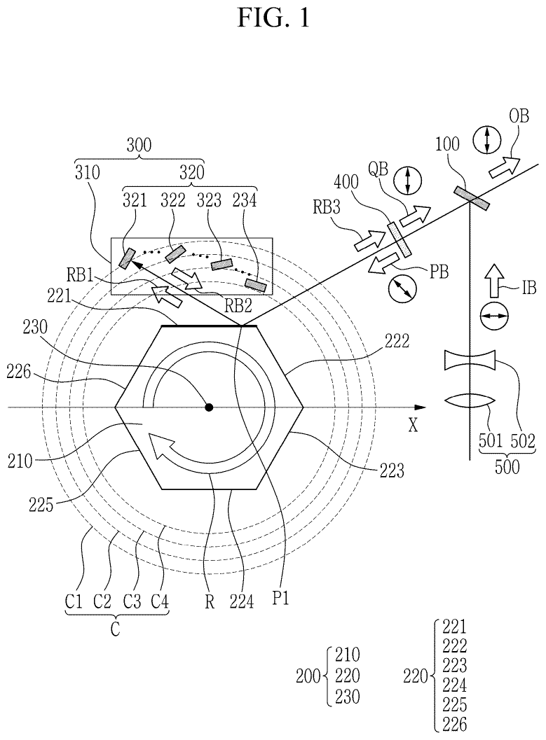

FIG. 1 is a schematic diagram of an optical delay generator according to an embodiment.

As shown in FIG. 1, an optical delay generator according to an embodiment of the present disclosure includes a polarizing beam splitter 100, a rotating polygonal mirror 200, a micromirror array 300, a phase delay member 400, and a reduction optical system 500.

The polarizing beam splitter 100 may split an incident beam IB by reflecting or transmitting the incident beam IB depending on the polarization state. At this time, the incident beam IB may be a polarized beam of a femtosecond to nanosecond laser beam. For better understanding and case of description, the description in FIG. 1 is based on the fact that the incident beam IB is a horizontally polarized beam.

The polarizing beam splitter 100 may reflect the incident beam IB, which is a horizontally polarized beam, and send the incident beam IB to the rotating polygonal mirror 200 through the phase delay member 400.

The rotating polygonal mirror 200 may include a rotating body 210, a plurality of reflecting surfaces 220, and a rotating shaft 230.

The rotating body 210 may be a flat plate with a polygonal shape. For example, the polygonal shape may be triangular to dodecagonal.

The plurality of reflecting surfaces 220 may be disposed on the side surface of the rotating body 210. The number of the plurality of reflecting surfaces 220 may be any one of 3 to 12 (i.e., between 3 and 12).

The rotating shaft 230 is installed at the center or central region of the rotating body 210 and may rotate the rotating body 210.

The rotating polygonal mirror 200 may rotate at a substantially constant speed based on rotation of the rotating shaft 230. In the present embodiment, the description will be based on a rotating polygonal mirror 200 having six reflecting surfaces 220 by way of example only. The six reflecting surfaces 220 may include a first reflecting surface 221, a second reflecting surface 222, a third reflecting surface 223, a fourth reflecting surface 224, a fifth reflecting surface 225, and a sixth reflecting surface 226.

The rotating polygonal mirror 200 may generate (e.g., redirect) or otherwise provide a first reflected beam RB1 by reflecting the incident beam IB reflected from the polarizing beam splitter 100 on any one of the plurality of reflecting surfaces 220. FIG. 1 shows a state in which the incident beam IB is reflected at a predetermined position P1 of the first reflecting surface 221 among the plurality of reflecting surfaces 220 to generate the first reflected beam RB1.

The micromirror array 300 may include an array body 310 and a plurality of micromirrors 320.

The array body 310 may be spaced apart from the rotating polygonal mirror 200.

The plurality of micromirrors 320 may have different inclination angles and may be disposed on the array body 310. The plurality of micromirrors 320 may be disposed to face one or more of the plurality of reflecting surfaces 220 of the rotating polygonal mirror 200. The plurality of micromirrors 320 may be disposed on a plurality of virtual circles C concentric with the rotating shaft 230 of the rotating polygonal mirror 200.

Therefore, the plurality of micromirrors 320 may not block the first reflected beam RB1 reflected from one reflecting surface 200 while the rotating polygonal mirror 200 rotates. Additionally, the plurality of micromirrors 320 may not block a second reflected beam RB2 so that the second reflected beam RB2 is incident on the reflecting surface 200 and reflected again.

In FIG. 1, for better understanding and ease of description, four micromirrors 321, 322, 323, and 324 are shown arranged on four virtual circles C1, C2, C3, and C4, respectively, but the arrangement of the plurality of micromirrors 320 is not necessarily limited thereto.

The micromirror array 300 may vertically reflect the first reflected beam RB1 (e.g., in a direction parallel to a direction or angle of incidence, or in a direction normal to a surface of the micromirrors 321, 322, 323, and 324) to generate the second reflected beam RB2. The second reflected beam RB2 generated by the micromirror array 300 may be sent to the rotating polygonal mirror 200 again.

At this time, the rotating polygonal mirror 200 may cause the second reflected beam RB2 to be reflected again at the predetermined position P1 of the first reflecting surface 221 to generate a third reflected beam RB3.

In FIG. 1, for better understanding and ease of description, only four micromirrors 321, 322, 323, and 324 that generate the second reflected beam RB2 are shown, but the number of micromirrors 320 is not necessarily limited thereto.

The phase delay member 400 may be disposed on the optical path between the polarizing beam splitter 100 and the rotating polygonal mirror 200. The phase delay member 400 may be a ¼ wavelength phase delay plate. Accordingly, the incident beam (horizontally polarized beam) reflected by the polarizing beam splitter 100 may be phase delayed by a ¼ wavelength to generate an inclined polarized beam PB (e.g., having a polarization that is rotated relative to that of the incident beam). The inclined polarizing beam PB is reflected from the first reflecting surface 221 of the rotating polygonal mirror 200 to generate the first reflected beam RB1.

In addition, the phase delay member 400 may further phase delay the third reflected beam RB3 generated by reflection from the first reflecting surface 221 of the rotating polygonal mirror 200 by a ¼ wavelength to generate a vertical polarized beam QB. The vertical polarized beam QB passes through the polarizing beam splitter 100 and becomes an output beam OB.

Here, the polarizing beam splitter 100 may generate the output beam OB by transmitting the vertical polarized beam QB generated when the third reflected beam RB3 passes through the phase delay member 400.

As such, the incident beam IB may pass through the polarizing beam splitter 100, the phase delay member 400, the rotating polygonal mirror 200, the micromirror array 300, the rotating polygonal mirror 200, the phase delay member 400, and the polarizing beam splitter 100 in order along an optical path, and become the output beam OB having a predetermined optical delay difference from the incident beam IB.

Meanwhile, the rotating polygonal mirror 200 may linearly change the optical delay difference between the incident beam IB and the output beam OB while rotating at a substantially constant speed. This will be described in detail below with reference to FIGS. 1 to 6.

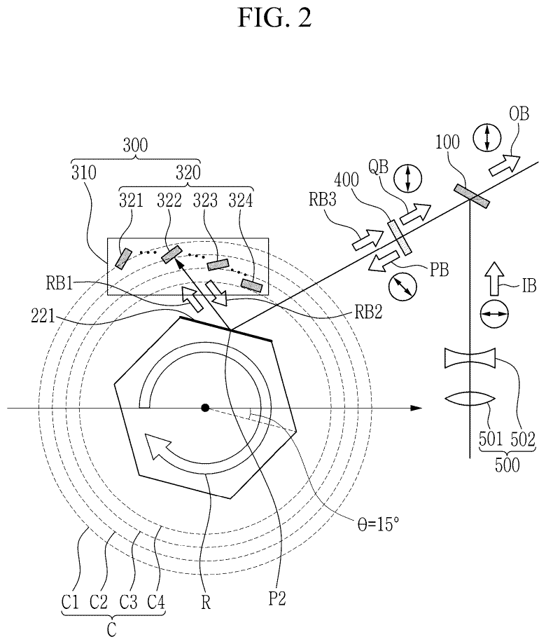

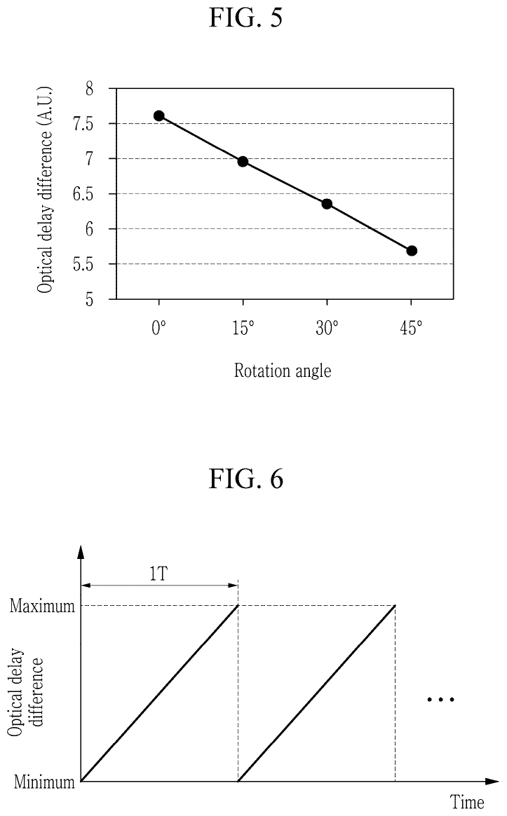

FIGS. 2 to 4 are diagrams illustrating a method of generating optical delay while rotating the rotating polygonal mirror of FIG. 1, FIG. 5 is a graph showing the optical delay difference according to the rotation angle of the rotating polygonal mirror of FIG. 1, and FIG. 6 is a graph showing the optical delay difference over time in the optical delay generator of FIG. 1.

As shown in FIG. 1, a rotation angle θ of the rotating polygonal mirror 200 in a state in which the first reflecting surface 221 of the rotating polygonal mirror 200 is arranged parallel to the X-axis direction is defined as 0 degrees. When the rotation angle θ of the rotating polygonal mirror 200 is 0 degrees, the first reflected beam RB1 generated by the incident beam IB reflecting from the first position P1 of the first reflecting surface 221 is reflected vertically from the first micromirror 321 of the plurality of micromirrors 320 to generate the second reflected beam RB2. The second reflected beam RB2 is then reflected again at the first position P1 of the first reflecting surface 221 to generate the third reflected beam RB3, which is transmitted through the phase delay member 400 and the polarizing beam splitter 100 to generate the output beam OB.

As shown in FIG. 2, when the rotating polygonal mirror 200 rotates clockwise R and the first reflecting surface 221 rotates 15 degrees based on the X-axis direction, the first reflected beam RB1 generated by the incident beam IB reflecting from a second position P2 of the first reflecting surface 221 is reflected vertically from the second micromirror 322 of the plurality of micromirrors (e.g. in a direction parallel to the direction of incidence) to generate the second reflected beam RB2. The second reflected beam RB2 is then reflected again from the second position P2 of the first reflecting surface 221 to generate the third reflected beam RB3, which is transmitted through the phase delay member 400 and the polarizing beam splitter 100 to generate the output beam OB. Here, the optical delay difference between the incident beam IB and the output beam OB when the rotation angle θ of the rotating polygonal mirror 200 is 15 degrees is smaller than the optical delay difference between the incident beam IB and the output beam OB when the rotation angle θ of the rotating polygonal mirror 200 is 0 degrees.

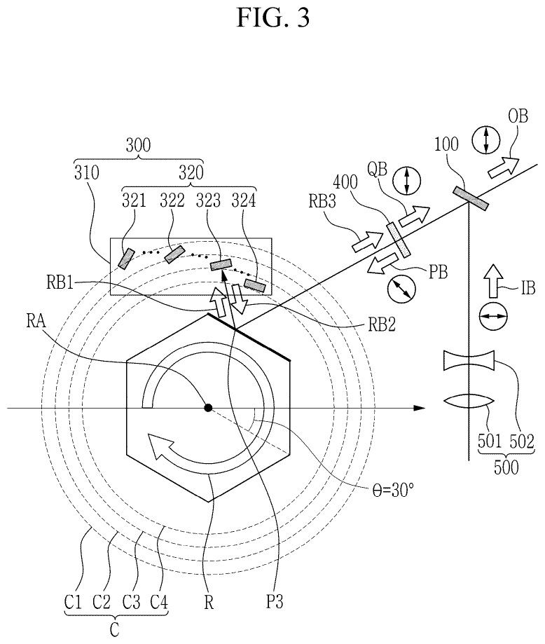

As shown in FIG. 3, when the rotating polygonal mirror 200 further rotates clockwise R and the first reflecting surface 221 rotates 30 degrees based on the X-axis direction, the first reflected beam RB1 generated by the incident beam IB reflecting from a third position P3 of the first reflecting surface 221 is reflected from the third micromirror 323 of the plurality of micromirrors 320 (e.g., in a direction parallel to the direction of incidence) to generate the second reflected beam RB2. The second reflected beam RB2 is then reflected again from the third position P3 of the first reflecting surface 221 to generate the third reflected beam RB3, which is transmitted through the phase delay member 400 and the polarizing beam splitter 100 to generate the output beam OB. Here, the optical delay difference between the incident beam IB and the output beam OB when the rotation angle θ of the rotating polygonal mirror 200 is 30 degrees is smaller than the optical delay difference between the incident beam IB and the output beam OB when the rotation angle θ of the rotating polygonal mirror 200 is 15 degrees.

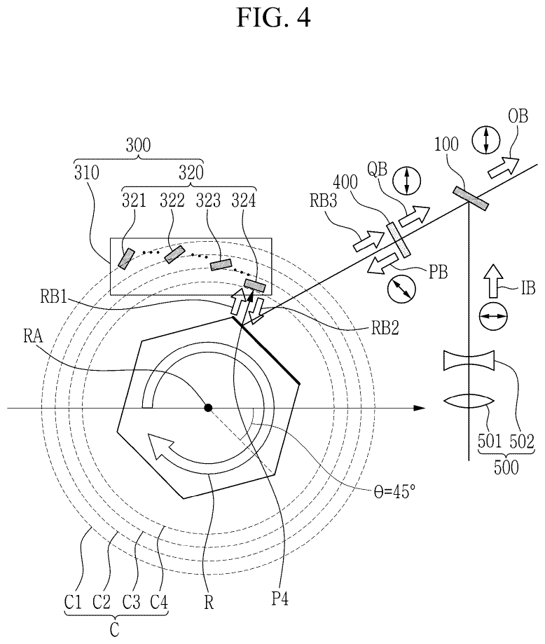

As shown in FIG. 4, when the rotating polygonal mirror 200 further rotates clockwise R and the first reflecting surface 221 rotates 45 degrees based on the X-axis direction, the first reflected beam RB1 generated by the incident beam IB reflecting from a fourth position P4 of the first reflecting surface 221 is reflected from the fourth micromirror 324 of the plurality of micromirrors 320 (e.g., parallel to a direction of incidence) to generate the second reflected beam RB2. The second reflected beam RB2 is then reflected again from the fourth position P4 of the first reflecting surface 221 to generate the third reflected beam RB3, which is transmitted through the phase delay member 400 and the polarizing beam splitter 100 to generate the output beam OB. Here, the optical delay difference between the incident beam IB and the output beam OB when the rotation angle θ of the rotating polygonal mirror 200 is 45 degrees is smaller than the optical delay difference between the incident beam IB and the output beam OB when the rotation angle θ of the rotating polygonal mirror 200 is 30 degrees.

As such, as the rotation angle θ of the rotating polygonal mirror 200 changes, the optical delay difference between the incident beam IB and the output beam OB may also change. Therefore, the optical delay difference may be easily changed at high speed. The rotation angle θ of the rotating polygonal mirror 200 changes in 15 degree increments represent an example embodiment; the increment of change of rotation angles θ in actual embodiments may vary and are not limited thereto.

For example, as shown in FIG. 5, when the rotation angle θ of the rotating polygonal mirror 200 is 0 degrees, the optical delay difference between the incident beam IB and the output beam OB is 7.5 A.U., when the rotation angle θ of the rotating polygonal mirror 200 is 15 degrees, the optical delay difference between the incident beam IB and the output beam OB is 7 A.U., when the rotation angle θ of the rotating polygonal mirror 200 is 30 degrees, the optical delay difference between the incident beam IB and the output beam OB is 6.4 A.U., and when the rotation angle θ of the rotating mirror 200 is 45 degrees, the optical delay difference between the incident beam IB and the output beam OB is 5.6 A.U. It can be seen that the optical delay difference changes linearly as the rotating polygonal mirror 200 rotates. Here, the unit of optical delay difference may be an arbitrary unit (A.U.).

In the case of a conventional optical delay generator that generates optical delay using a linear motor stage, a section in which the speed is decelerated and then accelerated again may occur at both ends where the moving direction of the linear motor stage changes, resulting in a non-uniform speed section. Therefore, a separate processing section may be needed to correct this. In this case, it may be difficult to change the optical delay difference at high speed and/or substantially constant speed, which may slow down the driving speed of the spectroscopic apparatus.

However, the optical delay generator according to an embodiment may change the optical delay difference at high speed by generating the optical delay difference between the incident beam and the output beam using a rotating polygonal mirror and a micromirror array. Additionally, by rotating the rotating polygonal mirror in one direction at a substantially constant speed, the optical delay difference may be varied at a substantially constant speed, and thus the optical delay difference may be changed linearly. Further, by changing the optical delay difference at high and substantially constant speed, the driving speed and signal-to-noise ratio of the spectroscopic apparatus may be improved.

Meanwhile, since the rotating polygonal mirror 200 has the plurality of reflecting surfaces 220, the reflecting surface on which the incident beam IB is incident may change as the rotating polygonal mirror 200 rotates. For example, when the number of the plurality of reflecting surfaces 220 of the rotating polygonal mirror 200 is 6, the reflecting surface on which the incident beam IB is incident may change from the first reflecting surface 221 to the second reflecting surface 222, from the second reflecting surface 222 to the third reflecting surface 223, from the third reflecting surface 223 to the fourth reflecting surface 224, from the fourth reflecting surface 224 to the fifth reflecting surface 225, and from the fifth reflecting surface 225 to the sixth reflecting surface 226.

At this time, the period during which the incident beam IB is reflected from one reflecting surface is defined as one period of the optical delay difference. Accordingly, the optical delay difference in any one of the plurality of reflecting surfaces 220 progresses for one period T from the minimum to the maximum.

For example, when the number of reflecting surfaces 220 of the rotating polygonal mirror 200 is six, one period T of the optical delay difference corresponds to a 60-degree rotation of the rotating polygonal mirror 200. In addition, when the number of the plurality of reflecting surfaces 220 of the rotating polygonal mirror 200 is three, one period T of the optical delay difference corresponds to a 120-degree rotation of the rotating polygonal mirror 200. When the number of the plurality of reflecting surfaces 220 of the mirror 200 is four, one period T of the optical delay difference corresponds to a 90-degree rotation of the rotating polygonal mirror 200. When the number of the plurality of reflecting surfaces 220 is 8, one period T of the optical delay difference corresponds to a 45-degree rotation of the rotating polygonal mirror 200. And when the number of the plurality of reflecting surfaces 220 is 12, one period T of the optical delay difference corresponds to a 30-degree rotation of the rotating polygonal mirror 200.

Therefore, as shown in FIG. 6, a plurality of periods T may be repeated at high speed while linearly changing the optical delay difference as the rotating polygonal mirror 200 is rotated. The repetition period of the optical delay difference may be up to 100 KHz.

Therefore, since averaging between each period is easy, the signal-to-noise ratio (SNR) may be improved.

Meanwhile, the reduction optical system 500 may be disposed on the optical path before the polarizing beam splitter 100. The reduction optical system may be formed of a combination of a convex lens 501 and a concave lens 502. The reduction optical system 500 may reduce the size of the inclined polarizing beam so that the reduction optical system 500 is easily reflected from the micro-sized micromirror array 300 (e.g., parallel to a direction of incidence).

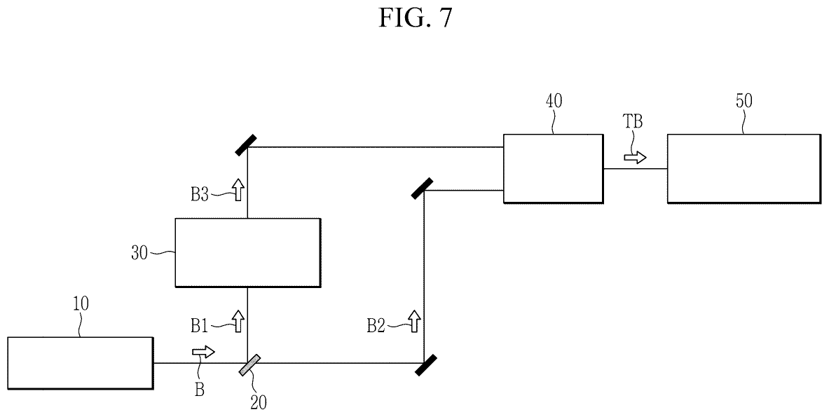

Hereinafter, a spectroscopic apparatus including an optical delay generator according to an embodiment will be described in detail with reference to FIGS. 1 to 6 along with FIG. 7.

FIG. 7 is a schematic diagram of a spectroscopic apparatus including an optical delay generator according to an embodiment.

As shown in FIG. 7, the spectroscopic apparatus includes a beam generator 10, a beam splitter 20, an optical delay generator 30, an irradiator 40, and a detector 50.

The beam generator 10 may generate a pulse beam B. The beam generator 10 may be a femtosecond to nanosecond laser generator, but is not necessarily limited thereto.

The beam splitter 20 may separate the pulse beam B generated by the beam generator 10 into a first pulse beam B1 and a second pulse beam B2.

The optical delay generator 30 may generate an optical delay beam by optically delaying the first pulse beam B1. The first pulse beam B1 may correspond to the incident beam IB in FIGS. 1 to 4, and an optical delay beam B3 may correspond to the output beam OB in FIGS. 1 to 4.

The optical delay generator may change the optical delay difference at a high and/or substantially constant speed by generating an optical delay difference between the first pulse beam B1 and the optical delay beam B3 using a rotating polygonal mirror and a micromirror array for example, as described above with reference to FIGS. 1 to 4.

The irradiator 40 may irradiate the optical delay beam B3 and the second pulse beam B2 to the sample. The second pulse beam B2 and the optical delay beam B3 may be irradiated to the sample with a time difference.

The detector 50 may detect the response of the sample to the optical delay beam B3 and the second pulse beam B2 having a time difference.

As such, the spectroscopic apparatus may improve the driving speed and signal-to-noise ratio of the spectroscopic apparatus by changing the optical delay difference at a high and/or substantially constant speed using the optical delay generator 30.

Although the present disclosure has been described through preferred embodiments as described above, it will be understood by those skilled in the art that the present disclosure is not limited thereto and various modifications and variations are possible without departing from the concept and scope of the claims described below.

What is claimed is:

1. An optical delay generator, comprising:
a polarizing beam splitter configured to split an incident beam by reflecting or transmitting the incident beam depending on a polarization state;
a rotating polygonal mirror configured to reflect the incident beam reflected from the polarizing beam splitter to provide a first reflected beam;
a micromirror array configured to reflect the first reflected beam and configured to send a provide a second reflected beam back to the rotating polygonal mirror; and
a phase delay member between the polarizing beam splitter and the rotating polygonal mirror,
wherein the polarizing beam splitter is configured to provide an output beam by transmitting a third reflected beam provided by reflecting the second reflected beam from the rotating polygonal mirror, and
wherein the output beam has an optical delay difference with respect to the incident beam.

2. The optical delay generator of claim 1, wherein the rotating polygonal mirror comprises:
a rotating body of a polygonal shape;
a plurality of reflecting surfaces on side surfaces of the rotating body; and
a rotating shaft configured to rotate the rotating body.

3. The optical delay generator of claim 2, wherein a number of the plurality of reflecting surfaces is between 3 and 12.

4. The optical delay generator of claim 2, wherein the rotating polygonal mirror is configured to rotate at a substantially constant speed.

5. The optical delay generator of claim 2, wherein the micromirror array comprises a plurality of micro-mirrors arranged at different inclination angles.

6. The optical delay generator of claim 5, wherein the micromirror array is spaced apart from the rotating polygonal mirror and arranged to face the plurality of reflecting surfaces of the rotating polygonal mirror.

7. The optical delay generator of claim 2, wherein the incident beam comprises polarized light.

8. The optical delay generator of claim 2, wherein the phase delay member is a ¼ wavelength phase delay plate.

9. The optical delay generator of claim 8, wherein the optical delay difference varies according to a change in a rotation angle of the rotating polygonal mirror.

10. The optical delay generator of claim 9, wherein rotation of the rotating polygon mirror is configured to change a reflecting surface among the plurality of reflecting surfaces on which the incident beam is incident, such that the optical delay difference changes linearly over one period, in which the incident beam is reflected from one of the reflecting surfaces.

11. A spectroscopic apparatus, comprising:
a beam generator configured to generate a pulse beam;
a beam splitter configured to separate the pulse beam generated by the beam generator into a first pulse beam and a second pulse beam;
an optical delay generator configured to provide an optical delay beam by optically delaying the first pulse beam;
an irradiator configured to irradiate the optical delay beam and the second pulse beam to a sample; and
a detector configured to detect a response of the sample to the optical delay beam and the second pulse beam,
wherein the optical delay generator comprises:
a polarizing beam splitter configured to split the first pulse beam by reflecting or transmitting the first pulse beam depending on a polarization state;
a rotating polygonal mirror configured to reflect the first pulse beam reflected from the polarizing beam splitter to provide a first reflected beam;
a micromirror array configured to reflect the first reflected beam and provide a second reflected beam back to the rotating polygonal mirror; and
a phase delay member between the polarizing beam splitter and the rotating polygonal mirror,
wherein the polarizing beam splitter is configured to provide an output beam by transmitting a third reflected beam generated by reflecting the second reflected beam from the rotating polygonal mirror,
wherein the output beam has an optical delay difference with respect to the first pulse beam.

12. The spectroscopic apparatus of claim 11, wherein the rotating polygonal mirror comprises:
a rotating body of a polygonal shape;
a plurality of reflecting surfaces on side surfaces of the rotating body; and
a rotating shaft configured to rotate the rotating body.

13. The spectroscopic apparatus of claim 12, wherein a number of the plurality of reflecting surfaces is between 3 and 12.

14. The spectroscopic apparatus of claim 12, wherein the rotating polygonal mirror is configured to rotate at a substantially constant speed.

15. The spectroscopic apparatus of claim 12, wherein the micromirror array comprises a plurality of micromirrors arranged at different inclination angles.

16. The spectroscopic apparatus of claim 15, wherein the micromirror array is spaced apart from the rotating polygonal mirror and arranged to face one of the plurality of reflecting surfaces of the rotating polygonal mirror.

17. The spectroscopic apparatus of claim 12, wherein the first pulse beam comprises polarized light.

18. The spectroscopic apparatus of claim 12, wherein the phase delay member is a ¼ wavelength phase delay plate.

19. The spectroscopic apparatus of claim 18, wherein the optical delay difference varies according to a rotation angle of the rotating polygonal mirror.

20. The spectroscopic apparatus of claim 19, wherein rotation of the rotating polygon mirror is configured to change a reflecting surface among the plurality of reflecting surfaces on which the first pulse beam is incident, such that the optical delay difference changes linearly over one period, in which the first pulse beam is reflected from one of the reflecting surfaces.
